(19) United States
(12) Patent Application Publication
(10) Pub. No.: US 2026/0308486 A1
(43) Pub. Date: Oct. 8, 2026

(54) PERFUME COMPOSITION

(71) Applicant: Givaudan SA, VERNIER (CH)

(72) Inventors: Nadia COCCO, Argenteuil (FR); Caroline JORDAN, Ashford (GB); Angus Peter MACMASTER, Ashford (GB)

(21) Appl. No.: 19/483,855

(22) PCT Filed: May 30, 2024
(86) PCT No.: PCT/EP2024/064853

§ 371 Date: Nov. 12, 2025

(30) Foreign Application Priority Data
May 30, 2023 (GB) 2308044.3

(51) Int. Cl. C11D 3/50; C11D 1/64; C11D 3/00; D06M 13/00

(52) U.S. Cl. CPC C11D 3/50; C11D 1/64; C11D 3/0068; D06M 13/005; C11D 2111/12

(57) ABSTRACT

There is provided a perfume composition and/or a textile care composition comprising 3-ethoxy-4-((4-methyl-6-phenylhex-3-en-1-yl)oxy)benzaldehyde for perfuming textiles comprising synthetic fibers.

### TECHNICAL FIELD

The present invention relates to a perfume composition and textile care compositions for perfuming textiles comprising synthetic fibers, and to the use of such fragrance composition to perfume textiles comprising polyester fibers, and to methods for perfuming a textile comprising synthetic fibers.

### BACKGROUND

It is well known that perfumes may be added to fabrics or textile surfaces to improve their pleasantness and enhance consumer acceptance for these products.

A classical way to impart a fragrance on textiles is to use fabric conditioners comprising cationic surfactants in the rinsing cycle, i.e. after the fabrics have been washed with a laundry detergent. In these products, it is commonly admitted that fragrance deposition is driven by the deposition of the cationic surfactant on the negatively charged cotton substrate.

In contrast, odorant molecules are much less deposited on textiles during the washing cycle because detergents are formulated in view of removing materials, such as dirt, greases and oils, from the textiles rather than depositing materials onto these textiles.

It is therefore a problem underlying the present invention to provide a method for perfuming textiles comprising synthetic fibers, in particular polyester-containing substrates, more particularly substrates containing polyester fibers and/or textiles.

The details, examples and preferences provided in relation to any particular one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

The present invention is based on the surprising finding that 3-ethoxy-4-((4-methyl-6-phenylhex-3-en-1-yl)oxy)benzaldehyde, which is a precursor suitable to release fragrance compounds, performs particularly well on textiles comprising synthetic fibers.

There is provided herein a perfume composition comprising 3-ethoxy-4-((4-methyl-6-phenylhex-3-en-1-yl)oxy)benzaldehyde for perfuming textiles comprising synthetic fibers.

3-ethoxy-4-((4-methyl-6-phenylhex-3-en-1-yl)oxy)benzaldehyde is a homoallyl ether of ethyl vanillin, able to release ethyl vanillin and benzyl acetone upon exposure to air. Exposure of the compound to air means exposure to molecular oxygen which might be responsible for the oxidative cleavage of the compound and the release of at least ethyl vanillin and benzyl acetone. The perceived odor is surprisingly described as vanilla, raspberry. The compound is described in WO2023065203.

When comparing the performance of the precursor on different textiles, it was surprisingly found that compound 3-ethoxy-4-((4-methyl-6-phenylhex-3-en-1-yl)oxy)benzaldehyde performs significantly better on textiles consisting of or comprising synthetic fibers than on pure cotton. The perfuming effect of the perfume composition can be accessed on textiles after drying of the textiles treated with said composition, so that the compound was exposed to air.

In the context of this application the term “textiles” refers to a broad range of products, including woven fabrics, fabrics obtained by other techniques like knitting, but also non-woven materials or coatings, fibers, filaments, threads and yarns.

Synthetic fibers refer to a group of fibers obtained by chemical synthesis, for example polyester, nylon, acrylic fibers (like Orlon), polyolefin fibers, and others. They can be used alone or in combination with other synthetic or non-synthetic fibers.

For example, the textiles comprising synthetic fibers are made of polyester or polyester-containing fibers. The polyester-containing fabrics and non-woven textiles may contain 100% pure polyester fibers or polyester fibers blended with other fibers, typically cotton and/or wool. Typical products include garments, curtains, draperies, upholstery, wall coverings, and carpets, as well as bed sheets and pillows. Typically, the part of polyester fiber in blends may range from 1% to 90%, more particularly 30 to 75%. For example, polyester/cotton blends may comprise 30 to 60% polyester. The blend may also comprise regenerated cellulose (e.g. viscose, know under the trade mark Rayon), polyamide and poly(ether-co-urethane) copolymers (known under the trade marks Elastane, Spandex or Lycra).

For example, there is provided a perfume composition comprising 3-ethoxy-4-((4-methyl-6-phenylhex-3-en-1-yl)oxy)benzaldehyde for perfuming textiles containing polyester.

The perfume composition may contain 3-ethoxy-4-((4-methyl-6-phenylhex-3-en-1-yl)oxy)benzaldehyde alone, or in combination with known odorant molecules selected from the extensive range of natural products, and synthetic molecules currently available, such as essential oils, alcohols, aldehydes and ketones, ethers and acetals, esters and lactones, macrocycles and heterocycles, and/or in admixture with one or more ingredients or excipients conventionally used in conjunction with odorants in perfume compositions, for example, carrier materials, and other auxiliary agents commonly used in the art. Known odorant molecules and other ingredients are described, for example, in “Perfume and Flavor Chemicals”, S. Arctander, Ed., Vol. I & II, Allured Publishing Corporation, Carol Stream, USA, 2003 and include fragrance compounds of natural or synthetic origin and essential oils.

In a further aspect, 3-ethoxy-4-((4-methyl-6-phenylhex-3-en-1-yl)oxy)benzaldehyde may be used in combination with other fragrance precursors, either with further homoallylether or with precursors possessing a different chemical structure. A combination of precursors allows releasing a perfume accord.

In one aspect of the present invention, there is provided a textile care composition comprising 3-ethoxy-4-((4-methyl-6-phenylhex-3-en-1-yl)oxy)benzaldehyde for perfuming textiles comprising synthetic fibers. For example, such textiles comprising synthetic fibers contain polyester.

The perfuming effect of the textile care composition can be accessed on textiles after drying of the textiles treated with said composition, so that the compound was exposed to air.

For example, a textile care composition can be selected from the group consisting of powder detergents, liquid detergents, sport laundry detergents, detergent pods, detergent sheets, washing soaps, washing tablets, laundry pre-treatments, fabric softeners, dryer sheets, textile fresheners, carpet cleaner, ironing aids, scent booster, and others.

The textile care composition of the present invention comprises at least 3-ethoxy-4-((4-methyl-6-phenylhex-3-en-1-yl)oxy)benzaldehyde and a consumer product base.

The consumer product base is designed for each product to fulfil the task the product is designed for. In general, the composition of a base of different types of detergents, softeners and other textile care compositions is well known.

For example, sport laundry detergents are specifically designed for sport clothes, which are textiles often comprising synthetic fibers, for examples polyester. After getting in contact with sweat, the related malodour can be eliminated by using sport laundry detergents which for example may contain cationic surfactants which have an anti-bacterial effect.

3-ethoxy-4-((4-methyl-6-phenylhex-3-en-1-yl)oxy)benzaldehyde can be used in textile care compositions in amounts from 0.001 to 30 weight % (e.g. up to about 10 or up to 20 weight %), more preferably between 0.01 and 5 weight %. However, these values are given only by way of example, since the experienced perfumer may also achieve effects or may create novel accords with lower or higher concentrations.

In one embodiment there is provided a textile care composition comprising an acceptable amount of compound 3-ethoxy-4-((4-methyl-6-phenylhex-3-en-1-yl)oxy)benzaldehyde. For example, the textile care composition may comprise 0.000001 weight % to 90 weight % (including 0.00001 weight %; 0.0001 weight %, 0.001 weight %, 0.01 weight %, 0.05 weight %, 0.1 weight %, 0.5 weight %, 1 weight %, 5 weight %, 8 weight %, 10 weight %, 15 weight %, 20 weight %, 25 weight %, 30 weight %, 50 weight %, 60 weight %, 65 weight %) of the compound based on the total amount of the textile care composition.

In a further aspect, there is provided the use of 3-ethoxy-4-((4-methyl-6-phenylhex-3-en-1-yl)oxy)benzaldehyde for perfuming textiles comprising synthetic fibers.

For example, there is provided the use of 3-ethoxy-4-((4-methyl-6-phenylhex-3-en-1-yl)oxy)benzaldehyde for perfuming synthetic fibers containing polyester.

The olfactive performance of compound 3-ethoxy-4-((4-methyl-6-phenylhex-3-en-1-yl)oxy)benzaldehyde on synthetic fibers, in particular on polyester fibers, makes it suitable for said use.

In a further aspect, there is provided the use of 3-ethoxy-4-((4-methyl-6-phenylhex-3-en-1-yl)oxy)benzaldehyde for malodour counteracting.

For example, there is provided the use of 3-ethoxy-4-((4-methyl-6-phenylhex-3-en-1-yl)oxy)benzaldehyde for malodour counteracting on textiles comprising synthetic fibers, in particular synthetic fibers containing polyester.

It was further found that 3-ethoxy-4-((4-methyl-6-phenylhex-3-en-1-yl)oxy)benzaldehyde shows good performance, when the textile was exposed to tumble dryer conditions, or to heat in general. For example, the textile was first treated with a fabric detergent and/or a fabric softener comprising 3-ethoxy-4-((4-methyl-6-phenylhex-3-en-1-yl)oxy)benzaldehyde and dried afterwards in a dryer. Alternatively, washed textiles were dried in a dryer in the presence of a dryer sheet comprising 3-ethoxy-4-((4-methyl-6-phenylhex-3-en-1-yl)oxy)benzaldehyde. From a such treated textile, the vanilla raspberry odor can be perceived well.

In addition to the olfactive performance of compound 3-ethoxy-4-((4-methyl-6-phenylhex-3-en-1-yl)oxy)benzaldehyde on synthetic fibers, it was further found that the compound has remarkable malodour counteracting properties. When releasing the odour in the presence of malodour, for example, male sweat malodour, the compound is able to provide the desired odour intensity, while lowering the malodour intensity.

The malodour counteracting effect of the compound can be accessed on textiles after drying of the textiles treated with said compound or a composition comprising it, so that the compound was exposed to air.

In a further aspect, there is provided a method for perfuming a textile comprising synthetic fibers, comprising the steps of
a) treating the textile with a composition comprising 3-ethoxy-4-((4-methyl-6-phenylhex-3-en-1-yl)oxy)benzaldehyde; and
b) exposing the textile to air.

For example, there is provided said method, wherein the textile contains polyester.

Compound 3-ethoxy-4-((4-methyl-6-phenylhex-3-en-1-yl)oxy)benzaldehyde as such is nearly odourless. When a textile is treated with a composition comprising said compound and dried, said compound is exposed to ambient air, therefore to molecular oxygen. The compound is cleaved, probably by oxidative cleavage, and releases the fragrant compounds ethyl vanillin and benzyl acetone, which can be perceived after a certain time.

In a further aspect, there is provided a method to enhance the fragrance perception of fragrances on textiles comprising synthetic fibers by using 3-ethoxy-4-((4-methyl-6-phenylhex-3-en-1-yl)oxy)benzaldehyde as fragrance ingredient.

The invention is now further described with reference to the following non-limiting examples. These examples are for the purpose of illustration only and it is understood that variations and modifications can be made by one skilled in the art.

### EXAMPLES

### Example 1: Performance on Textiles with Different Fibers

0.2% by weight of 3-ethoxy-4-((4-methyl-6-phenylhex-3-en-1-yl)oxy)benzaldehyde was incorporated into unperfumed liquid detergent base by magnetic stirring at room temperature for 24 h.

A 40° C. machine wash cycle was performed using 65 g of the above prepared liquid detergent sample and one odour-neutral towel (100% cotton), one odour-neutral T-Shirt comprising polyester fibers (95% cotton+5% polyester), and one odour-neutral synthetic T-Shirt (100% polyester). The wet and line-dried fabric (1, 3 and 7 days) was assessed by a panel of experts with regard to odour intensity. The odour intensity was recorded on an intensity scale of 0 (odourless) to 5 (extremely strong).

TABLE 1

| Fabric | Wet | D + 1 | D + 3 | D + 7 |
|---|---|---|---|---|
| Polyester 100% | 1.3 | 3.0 | 2.8 | 2.8 |
| Cotton 95% + Polyester 5% | 1.0 | 1.0 | 1.8 | 1.8 |
| Cotton 100% | 1.0 | 0.5 | 1.0 | 0.8 |

As can be seen from Table 1 virtually no odour was released from the cotton fabric washed with detergent sample containing 3-ethoxy-4-((4-methyl-6-phenylhex-3-en-1-yl)oxy)benzaldehyde, whereas the polyester fabric washed with the same sample under same conditions exhibited strong vanilla raspberry fragrance after 1, 3 and 7 days. On mixed fibers comprising polyester, the fragrance was perceived after 3 and 7 days, with lower intensity in comparison to 100% polyester fabric.

### Example 2: Odour Strength

100% Polyester fabric (5 cm×5 cm) was stripped before use. They were then washed in European washing machines (40° C.-1,000 spin/min) with one unit dose (65 g) used per wash load. The unit dose contained either 0.20% of 3-ethoxy-4-((4-methyl-6-phenylhex-3-en-1-yl)oxy)benzaldehyde (“Compound”, sample 3), 0.20% of 1:1 Mix by weight of ethyl vanillin and benzyl acetone (sample 1), or unperfumed liquid detergent base (sample 2).

The total wash load was 1.6 kg made up of test cloths and hand towels (100% cotton) as ballast. The cloth was line dried and left in a perfume free room at 25° C. for 4 days. One hour prior to assessment the cloth was placed in a 125 ml amber jar and sealed with a lid. Each sample was coded with a random code number. For the assessment, panelists are asked to remove the lid from the jar, sniff the sample, replace the lid and make their response.

The overall perceived intensity was assessed by the trained sensory panel using a 0-100 line scale. All overall perceived intensities were scaled against an internal reference sample set at 15. The order of samples assessed by the panelists was pre-determined using a balanced randomisation. The samples were assessed in a sequential monadic way, and 2 minutes were left between assessing each sample to minimise fragrance and malodour carry-over effects. The samples were assessed twice by 20 panelists, thus giving 40 assessments per sample.

Before analysis, the data was checked for outliers and extreme violations to normality.

Reliability of the data was checked and data of panelists with poor discrimination, consensus or repeatability may have been removed from the analysis. The data was analysed using analysis of variance (ANOVA). A 5% significance level (95% confidence level) was used. The ANOVA has product, panelist, and replicate as factors. Pairwise comparisons of the products were done using the Benjamini-Hochberg correction for multiple testing. The estimated product means are reported. It is indicated with letters if the product means are statistically significantly different from each other: if they are not, then they share the same letter.

| | | Perceived | |
|---|---|---|---|
| | | Odour | Significance |
| Sample | Composition | Intensity | of Differences |
| 1 | 0.2% Mix (1:1 Ethyl vanillin | 14.4 | A |
| | 0.10% + Benzyl Acetone 0.10%) | | |
| 2 | Unperfumed Base | 15.6 | A |
| 3 | 0.2% Compound | 21.3 | C |

Compound 3-ethoxy-4-((4-methyl-6-phenylhex-3-en-1-yl)oxy)benzaldehyde has a significantly higher fragrance intensity than the two molecules it releases in equivalent dosage.

### Example 3: Malodour Counteractancy

100% Polyester fabric (5 cm×5 cm) was stripped before use. They were then washed in European washing machines (40° C.-1,000 spin/min) with one unit dose (65 g) used per wash load. The unit dose contained either 0.20% of 3-ethoxy-4-((4-methyl-6-phenylhex-3-en-1-yl)oxy)benzaldehyde (sample 1), 0.20% of 1:1 Mix by weight of ethyl vanillin and benzyl acetone (sample 2) or unperfumed liquid detergent base (sample 2).

The total wash load was 1.6 kg made up of test cloths and hand towels (100% cotton) as ballast. The cloth was line dried and left overnight in a perfume free room at 25° C. for 4 days. One hour prior to assessment, 20 μL of dilute Male Sweat malodour was pipetted onto filter paper and introduced into a 125 ml amber jar. The cloth was then placed on the filter paper and the jar was sealed with a lid. Each sample was coded with a random code number. For assessment, panelists were asked to remove the lid from the jar, sniff the sample, replace the lid and make their response.

The malodour and fragrance perceived intensities were assessed by the trained sensory panel using a 0-100 line scale. All malodour and fragrance perceived intensities were scaled against the malodour control sample. The malodour perceived intensity was set at 35 for Male Sweat malodour and the fragrance perceived intensity was set at 0.

The order of samples assessed by the panelists was pre-determined using a balanced randomisation. The samples were assessed in a sequential monadic way, and 5 minutes were left between assessing each sample to minimise fragrance and malodour carry-over effects. The samples were assessed twice by 20 panelists, thus giving 40 assessments per sample.

Before analysis, the data was checked for outliers and extreme violations to normality.

Reliability of the data was checked and data of panelists with poor discrimination, consensus or repeatability may have been removed from the analysis. The data was analysed using analysis of variance (ANOVA). A 5% significance level (95% confidence level) was used. Separate ANOVAs were carried out for malodour and fragrance intensity. The ANOVA have product, panelist, and replicate as factors. Pairwise comparisons of the products were done using the Benjamini-Hochberg correction for multiple testing. The estimated product means are reported. It is indicated with letters if the product means are statistically significantly different from each other: if they are not, then they share the same letter.

### a) Perceived Malodour Intensity

| | | Perceived | |
|---|---|---|---|
| | | Malodour | Significance |
| Sample | Composition | Intensity | of Differences |
| 1 | 0.2% Compound + Male Sweat | 16.2 | A |
| 2 | 0.2% Mix (1:1 Ethyl vanillin | 26.2 | B |
| | 0.10% + Benzyl Acetone | | |
| | 0.10%) + Male Sweat | | |
| 3 | Unperfumed Base + Male Sweat | 27.6 | B |
| 4 | Male Sweat | 27.6 | B |

Where the same letter is shown in the “significance of differences” column there are no statistically significant differences between the relevant figures.

When assessed from jars, cloth washed with the sample comprising 3-ethoxy-4-((4-methyl-6-phenylhex-3-en-1-yl)oxy)benzaldehyde had a significantly lower perceived malodour intensity (PMI) than the fabric washed with Mix 1:1 Ethyl vanillin 0.10%+Benzyl Acetone 0.10% or unperfumed base which were not perceived to be significantly different.

### b) Perceived Fragrance Intensity

| | | Perceived | |
|---|---|---|---|
| | | Fragrance | Significance |
| Sample | Sample | Intensity | of Differences |
| 5 | Male Sweat | 4.9 | A |
| 6 | 0.2% Mix (1:1 Ethyl vanillin | 5.6 | A |
| | 0.10% + Benzyl Acetone | | |
| | 0.10%) + Male Sweat | | |
| 7 | Unperfumed Base + Male Sweat | 5.7 | A |
| 8 | 0.2% Compound + Male Sweat | 18.9 | B |

Where the same letter is shown in the “significance of differences” column there are no statistically significant differences between the relevant figures.

When the 4-day dry cloth was assessed against sample 5 in the presence of the Male Sweat Malodour, sample 8 was significantly stronger in perceived fragrance intensity (PFI) than fabric washed with Mix 1:1 Ethyl vanillin 0.10%+Benzyl Acetone 0.10% (sample 6) or unperfumed base (sample 7), which were not perceived to be significantly different in PFI.

The use of 3-ethoxy-4-((4-methyl-6-phenylhex-3-en-1-yl)oxy)benzaldehyde on polyester fabrics significantly reduced the perceived intensity of the sweat malodour. It further causes a significantly higher malodour reduction efficacy than the two molecules it releases, ethyl vanillin and benzyl acetone. The used compound was perceivable in the presence of the malodour and shows a significantly higher fragrance intensity than the two molecules it releases.

1. A perfume composition comprising 3-ethoxy-4-((4-methyl-6-phenylhex-3-en-1-yl)oxy)benzaldehyde for perfuming textiles comprising synthetic fibers.

2. The perfume composition according to claim 1, wherein the synthetic fibers comprise polyester.

3. A textile care composition comprising 3-ethoxy-4-((4-methyl-6-phenylhex-3-en-1-yl)oxy)benzaldehyde for perfuming textiles comprising synthetic fibers.

4. The textile care composition according to claim 3, wherein the synthetic fibers comprise polyester.

5. The textile care composition according to claim 3, wherein said textile care composition is selected from the group consisting of powder detergents, liquid detergents, sport laundry detergents, detergent pods, detergent sheets, washing soaps, washing tablets, laundry pre-treatments, fabric softeners, dryer sheets, textile fresheners, carpet cleaners, ironing aids and scent boosters.

6. The textile care composition according to claim 3, further comprising cationic surfactants.

7. (canceled)

8. (canceled)

9. (canceled)

10. (canceled)

11. A method for perfuming a textile comprising synthetic fibers comprising:
a) treating the textile with the composition according to claim 1, and
b) exposing the treated textile to air.

12. The method for perfuming a textile according to claim 11, wherein the textile comprises contains polyester.

13. A method for enhancing the fragrance perception of fragrances on a textile comprising synthetic fibers comprising treating the textile with a fragrance ingredient comprising 3-ethoxy-4-((4-methyl-6-phenylhex-3-en-1-yl)oxy)benzaldehyde.

14. The method for perfuming a textile according to claim 11, wherein the composition is selected from the group consisting of powder detergents, liquid detergents, sport laundry detergents, detergent pods, detergent sheets, washing soaps, washing tablets, laundry pre-treatments, fabric softeners, dryer sheets, textile fresheners, carpet cleaners, ironing aids and scent boosters.

15. The method for perfuming a textile according to claim 11, wherein the composition further comprises cationic surfactants.

16. A method of counteracting malodour comprising treating a textile comprising synthetic fibers with the composition of claim 1.

17. The method of counteracting malodour according to claim 16, wherein the textile comprises polyester.
